(19) United States
(12) Patent Application Publication
(10) Pub. No.: US 2010/0296489 A1
(43) Pub. Date: Nov. 25, 2010

(54) Method of Uplink Multi-Cell Joint Detection in a Time Division-Synchronous Code Division Multiple Access System

(75) Inventors: Jun Zhang, Guangdong Province (CN); Meiling Ding, Guangdong Province (CN); He Huang, Guangdong Province (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ZTE CORPORATION, Shenzhen, Guangdong (CN)

(21) Appl. No.: 12/808,245

(22) PCT Filed: Dec. 18, 2007
(86) PCT No.: PCT/CN2007/003655

§ 371 Date: Jun. 15, 2010

(51) Int. Cl. H04B 7/216

(52) U.S. Cl. 370/335

(57) ABSTRACT

The present invention discloses a method for uplink multi-cell joint detection in a Time Division-Synchronous Code Division Multiple Access system to realize uplink multi-cell joint detection by a Node B. The method comprises: a radio network controller sending neighbor cell channel updating information to neighbor Node Bs of a cell where a user terminal is located when a Node B application part protocol process happens at an Iub interface to establish a radio link for the user terminal; and the neighbor Node Bs adding information of the user terminal into an uplink multi-cell joint detection information of the cell where uplink joint detection is required to be performed for the user terminal after receiving the neighbor cell channel updating information. The method of the present invention realizes uplink multi-cell joint detection by a Node B.

### TECHNICAL FIELD

The present invention relates to wireless communication systems, and more particularly, to a method for uplink multi-cell joint detection in a Time Division-Synchronous Code Division Multiple Access (TD-SCDMA) system.

### TECHNICAL BACKGROUND

Since Code Division Multiple Access (CDMA) system is a self-interference system, in the TD-SCDMA system, the interference between users limits further improvement of quality of service (QoS). Thus, a user equipment (UE) implements joint detection for its cell in downlink; while a Node B (base station) implements joint detection for its cell in uplink.

In 3GPP 25.331RRC (radio resource control) protocol, scrambling code information of neighbor cells is carried in a same-frequency measurement control message. Therefore, the UE may implement blind detection for neighbor cells in downlink as long as it has ability enough to do so. However, in 3GPP 25.433NBAP (Node B application part) protocol, since information of any of the neighbor cells is unable to be provided to cells of the Node B, the Node B cannot implement multi-cell joint detection in uplink. For users of other neighbor cells, especially in the vicinity of a switching zone, the interference caused by the UE can not be eliminated in its cell, thus, uplink transmission power of the UE in this cell will be increased in order to ensure QoS of the users, and users in other cells will raise the power accordingly, which results in the vicious circle and instability of the whole system.

### SUMMARY OF THE INVENTION

A technical problem to be solved by the present invention is to provide a method for uplink multi-cell joint detection in order for Node B to implement the uplink multi-cell joint detection in a TD-SCDMA system.

In order to solve the technical problem described above, the present invention provides a method for uplink multi-cell joint detection in a Time Division-Synchronous Code Division Multiple Access (TD-SCDMA) system comprising:

a radio network controller sending neighbor cell channel updating information to neighbor Node Bs of a cell where a user terminal is located when a Node B application part protocol process happens at an Iub interface to establish a radio link for the user terminal; and

the neighbor Node Bs adding information of the user terminal into uplink multi-cell joint detection information of the cell where uplink joint detection is required to be performed for the user terminal after receiving the neighbor cell channel updating information.

The method may further comprise:

the radio network controller sending the neighbor cell channel updating information to the neighbor Node Bs when notifying a Node B where the user terminal is located to reconfigure the radio link; and

the neighbor Node Bs receiving the neighbor cell channel updating information, and updating the information of the user terminal in the uplink multi-cell joint detection information.

The method may further comprise:

the radio network controller sending neighbor cell channel deletion information to the neighbor Node Bs when the Node B application part protocol process happens at the Iub interface to delete the radio link of the user terminal; and

the neighbor Node Bs deleting the information of the user terminal in the uplink multi-cell joint detection information after receiving the neighbor cell channel deletion information.

Further, the neighbor cell channel deletion information may include a user terminal identifier.

In the method, the Node B application part protocol process to establish the radio link for the user terminal may include a radio link setup process or a radio link addition process.

In the method, the neighbor Node Bs of the cell where the user terminal is located are Node Bs where cells which are found from neighbor cells of the cell where the user terminal is located are located, the neighbor Node Bs including a cell which contains a frequency point at which the established radio link is present and is also the cell where uplink joint detection is required to be performed for the user terminal.

In the method, the neighbor cell channel updating information may include a user terminal identifier as well as a carrier frequency on which the established radio link is present and a physical channel occupied by the established radio link.

Further, the neighbor cell channel updating information may also include scrambling codes of the cell where the user terminal is located and a list of cells where uplink joint detection is required to be performed by the neighbor Node Bs.

Using the method for uplink multi-cell joint detection in accordance with the present invention may cause the Node B to implement the uplink multi-cell joint detection so as to eliminate interference information between the UEs in neighbor cells and improve system capacity and quality of service (QoS) while reducing greatly Iub interface messages. Furthermore, the more the Node Bs are, the more obvious the effect is.

### BRIEF DESCRIPTION OF THE DRAWINGS

FIG. 1 illustrates a flow chart of steps of an example of the method of the present invention;

FIG. 2 illustrates a flow chart of steps of an application example of the method of the present invention;

FIG. 3 illustrates a schematic diagram of an application scenario of three Node Bs including a total of 9 cells; and

FIG. 4 illustrates a flow chart of steps of another application example of the method of the present invention.

### PREFERRED EMBODIMENTS OF THE INVENTION

The present invention will be further described in detail below in conjunction with the accompanying drawings and the preferred embodiments.

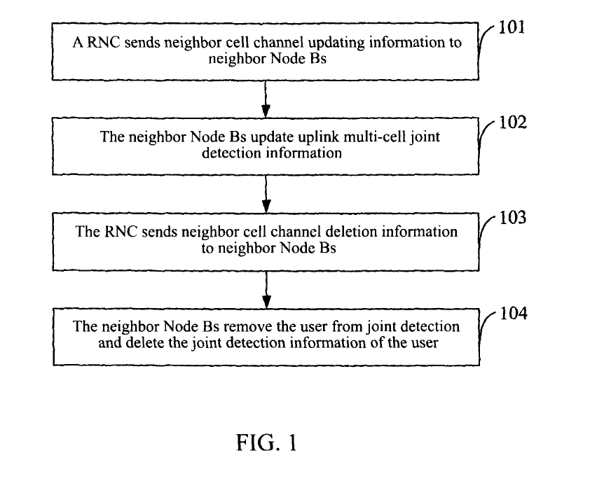

FIG. 1 illustrates a flow chart of steps of an example of the method of the present invention comprising steps:

step 101: a radio network controller (RNC) sends neighbor cell channel updating information to neighbor Node Bs of a cell where a user terminal is located when a process to establish a radio link for the user happens at an Iub interface;

step 102: the neighbor Node Bs update uplink multi-cell joint detection information;

step 103: the RNC sends neighbor cell channel deletion information to the neighbor Node Bs; and

step 104: the neighbor Node Bs remove the user from joint detection and delete the joint detection message of the user.

In the step 101, the determination process for the neighbor Node Bs is to find a cell containing a frequency point at which the established radio link is present from neighbor cells configured for the cell where the user terminal is located (which will be referred to as the current cell hereinafter). Node Bs where these cells are located are the neighbor Node Bs.

Assuming that the frequency point at which a NBAP process to establish the radio link is initiated in the current cell is F, a neighbor cell set comprised of all the neighbor cells of the current cell is S, S={Cell1, Cell2, . . . Cello}, where o is the number of elements in the neighbor cell set S.

If there is the frequency point F in Celli (i≦o) in S, then the cell Celli is put into a same-frequency neighbor set Sc={Cell1, Cell2, Cellp}, where p represents the number of elements in the set Sc, p≦o. The neighbor cells in the set Sc are classed by the Node Bs where they are located, that is, the neighbor cells which are located in the same Node B are classed into the same set:
Sni={Cellni_1, Cellni_2, . . . Cellni mi}, where i=0, 1, q,
   where Sni represents a set of the neighbor cells of the current cell in Node B; q represents the number of elements of the set Sn, qp; mi represents the number of

$${\sum }_{i = 1}^{q} mi = p .$$

eLements of the set Sni, m≧1; Sni∩Snj=φ, where i≠j, i,j≧q; and

The frequency point of the NBAP process is the frequency point at which the radio link established in the NBAP process is present. The neighbor cell channel updating information includes a UE identifier (e.g., which may be CRNC CCID), a carrier frequency on which the established radio link is present and a physical channel occupied by the established radio link. The neighbor channel updating message may further include scrambling codes of the cell where the UE is located and information regarding to a list of cells where uplink joint detection is required to be performed by the neighbor Node Bs.

In the above example of the present invention, the process happening at the Iub interface to establish the radio link for the user includes radio link setup or radio link addition. The present invention will be described specifically below using two application examples for the radio link setup.

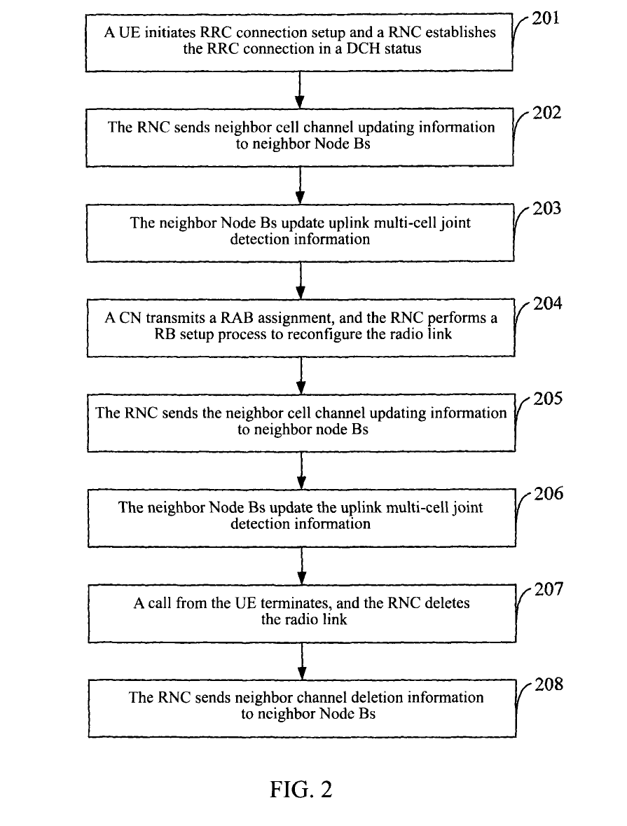

FIG. 2 illustrates a flow chart of steps of an application example of the method of the present invention. A synchronized radio link reconfiguration commit process for reconfiguring the radio link is further included in this application example to describe the present invention in more detail. Steps in this application example will be described below.

Step 201: a user U (whose UE identifier is U) initiates radio resource control (RRC) connection setup and a RNC decides to establish the RRC connection of the UE in a dedicated channel (DCH) status to establish a radio link (RL) at an Iub interface.

Step 202: after the radio link setup is completed, the RNC sends neighbor cell channel updating information to neighbor Node Bs.

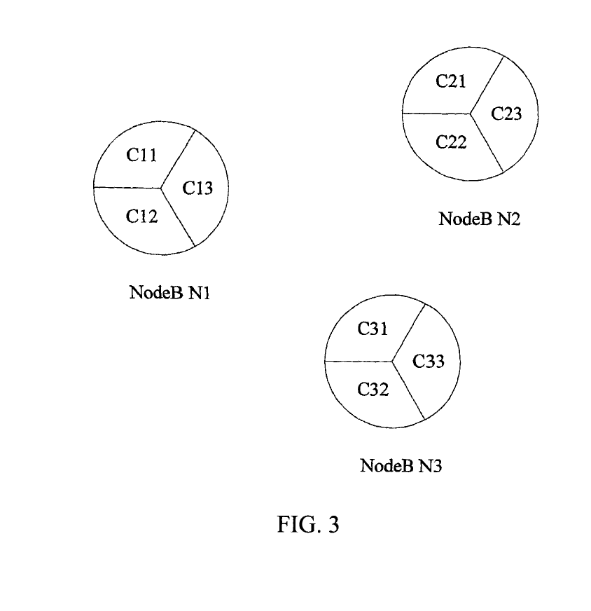

Based on a schematic diagram of an application scenario of the present invention as shown in FIG. 3, a determination principle for neighbor Node Bs in this step is described as follow.

As shown in FIG. 3, there is a total of three Node Bs (Node B N1, Node B N2 and Node B N3) in the application scenario, each Node B being a cell with three-carrier (F1, F2 and F3) three-sector configuration (each Node B having 3 cells and each cell having 3 carriers). Thus, there are 9 cells (C11, C12, C13; C21, C22, C23; C31, C32, C33) in total, which are neighbor cells relative to each other.

If the radio link of the user U is established in the cell C11, a frequency point is F1, a scrambling code is M1 and a channelization code is CC16/1, then a set comprised of all the neighbor cells of the current cell (i.e., the cell C11) is a neighbor cell set S={C12, C13, C21, C22, C23, C31, C32, C33}, where the number of elements of the set S is 8. The frequency point F1 exists in each cell in the set S, thus, each cell in S is put into a same-frequency neighbor cell set Sc. In this application example, Sc=S, p represents the number of elements of the set Sc, p=8. The neighbor cells in the set Sc are classed by the Node Bs where they are located, that is, the neighbor cells which are located in the same Node B are classed into the same set:

Sn1={C12, C13}, m1=2;

Sn2={C21, C22, C23}, m2=3;

Sn3={C31, C32, C33}, m3=3;

where:

$$Sni ⋂ Snj = φ , where i \neq j , i , j \leq 3 ;$$

$${\sum }_{i = 1}^{q} mi = p .$$

The RNC sends neighbor cell channel updating information, which contains the UE identifier U, the scrambling code M1 of the cell where the user is located, the carrier frequency F1 on which the established radio link is present, the physical channel CC16/1 occupied by the established radio link and information regarding to a list of cells where uplink joint detection is required to be performed by the neighbor Node Bs, to N1, N2 and N3, respectively.

For neighbor Node B N1, the list of the cells where joint detection is performed includes C12 and C13; for neighbor Node B N2, the list of the cells where joint detection is performed includes C21, C22 and C23; and for neighbor Node B N3, the list of the cells where joint detection is performed includes C31, C32 and C33.

Step 203: the neighbor Node Bs receive the neighbor cell channel updating information to update uplink multi-cell joint detection information.

In this step, for N1, if the user U does not exist, information of the user is newly created to be added into an uplink joint detection process for the cell C12 and C13; for N2, if the user U does not exist, information of the user is newly created to be added into an uplink joint detection process for C21, C22 and C23; and for N3, if the user U does not exist, information of the user is newly created to be added into an uplink joint detection process for C231, C32 and C33.

Step 204: a core network (CN) transmits a radio access bearer (RAB) assignment, and the RNC reconfigure the radio link at the Iub interface during a radio bearer (RB) setup process.

Step 205: after transmitting the synchronized radio link reconfiguration commit message to a Node B where the user U is located, the RNC sends the neighbor cell channel updating information to neighbor node Bs.

If the RL of the user U is reconfigured in the cell C11, the frequency point is F1, the scrambling code is M1 and the channelization code is changed to CC8/1, then the RNC sends neighbor cell channel updating information to N1, N2 and N3, respectively, with the UE identifier U, the scrambling code M1 of the cell where the user is located, the carrier frequency F1, the physical channel information CC8/1 in each piece of neighbor cell channel updating information being the same, respectively. For the list of cells where uplink joint detection is required to performed by the neighbor Node Bs, the step 202 may be referred to.

Step 206: the neighbor Node Bs receive the neighbor cell channel updating information to update the uplink multi-cell joint detection information.

In this step, for N1, if the user U exists, the information of the user is updated to update the uplink joint detection process for the cell C12 and C13; for N2, if the user U exists, the information of the user is updated to update the uplink joint detection process for C21, C22 and C23; and for N3, if the user U exists, the information of the user is updated to update the uplink joint detection process for C31, C32 and C33.

Step 207: when a call from the UE terminates, the CN triggers an Iu release process and the RNC performs a RRC release and a radio link deletion process.

Step 208: the RNC sends a neighbor channel deletion message containing the user identifier U to N1, N2 and N3, respectively.

For N1, the uplink joint detection process for the cell C12 and C13 is updated and the information of the user U in the joint detection message is deleted; for N2, the uplink joint detection process for C21, C22 and C23 is updated and the information of the user U in the joint detection message is deleted; and for N3, the uplink joint detection process for C231, C32 and C33 is updated and the information of the user U in the joint detection message is deleted.

It can be seen from this application example that updating the uplink multi-cell joint detection information comprises adding or deleting the information of the user terminal in the uplink multi-cell joint detection information and modifying the information of the user terminal in the uplink multi-cell joint detection information.

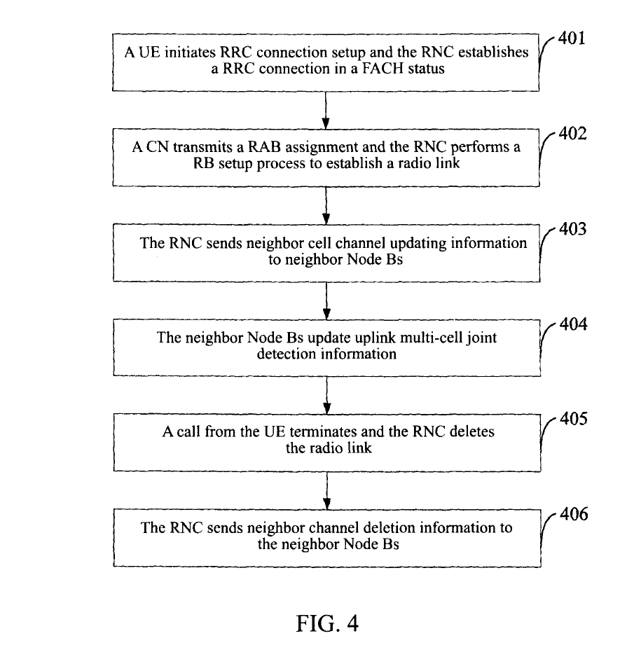

Still based on the schematic diagram of the application scenario of the present invention as shown in FIG. 3, FIG. 4 illustrates a flow chart of steps of another application example of the method of the present invention. The steps will be described below.

Step 401: a user U initiates RRC connection setup and a RNC decides to establish the RRC connection of the UE in a forward access channel (FACT-1) status.

Step 402: a CN transmits a RAB assignment and the RNC performs a RB setup process to establish a radio link at an Iub interface.

Step 403: after the radio link setup is completed, the RNC sends neighbor cell channel updating information to neighbor Node Bs. For the processing of the neighbor Node Bs in this step, the step 202 may be referred to. If the RL of the user U is established in the cell C11, the frequency point is F1, the scrambling code is M1 and the channelization code is CC8/1, then the RNC sends neighbor cell channel updating information to N1, N2 and N3, respectively, with the UE identifier U, the scrambling code M1 of the cell where the user is located, the carrier frequency F1, the physical channel information CC8/1 in each piece of neighbor cell channel updating information being the same, respectively.

For neighbor Node B N1, the list of the cells where joint detection is performed includes C12 and C13; for neighbor Node B N2, the list of the cells where joint detection is performed includes C21, C22 and C23; and for neighbor Node B N3, the list of the cells where joint detection is performed includes C31, C32 and C33.

Step 404: the neighbor Node Bs receive the neighbor cell channel updating information to update uplink multi-cell joint detection information.

In this step, for N1, if the user U does not exist, the information of the user is newly created to be added into an uplink joint detection process for the cell C12 and C13; for N2, if the user U does not exist, the information of the user is newly created to be added into an uplink joint detection process for C21, C22 and C23; and for N3, if the user U does not exist, the information of the user is newly created to be added into an uplink joint detection process for C31, C32 and C33.

Step 405: when a call from the UE terminates, the CN triggers an lu release process and the RNC performs a RRC release and radio link deletion process.

Step 406: the RNC sends a neighbor channel deletion message containing the user identifier U to N1, N2 and N3, respectively.

In this step, for N1, the uplink joint detection process for the cell C12 and C13 is updated and the information of the user U in the joint detection message is deleted; for N2, the uplink joint detection process for C21, C22 and C23 is updated and the information of the user U in the joint detection message is deleted; and for N3, the uplink joint detection process for C31, C32 and C33 is updated and the information of the user U in the joint detection message is deleted.

Using the method for uplink multi-cell joint detection in accordance with the present invention can implement the uplink multi-cell joint detection at the Node B. According to the principle of joint detection, the method in accordance with the present invention eliminates interference information between the UEs in neighbor cells and improves system capacity and quality of service (QoS) while reducing greatly Iub interface messages. Furthermore, the more the Node Bs are, the more obvious the effect is.

Various modifications may be made to the embodiments described above by those skilled in the art without departing from the spirit and scope of the present invention defined by the appended claims. Therefore, the scope of the present invention is not limited to the above description, but is defined by the scope of the claims.

What we claim is:

1. A method for uplink multi-cell joint detection in a Time Division-Synchronous Code Division Multiple Access system comprising:
a radio network controller sending neighbor cell channel updating information to neighbor Node Bs of a cell where a user terminal is located when a Node B application part protocol process happens at an Iub interface to establish a radio link for the user terminal; and
the neighbor Node Bs adding information of the user terminal into an uplink multi-cell joint detection information of the cell where uplink joint detection is required to be performed for the user terminal after receiving the neighbor cell channel updating information.

2. The method according to claim 1, further comprising:
the radio network controller sending the neighbor cell channel updating information to the neighbor Node Bs when notifying a Node B where the user terminal is located to reconfigure the radio link; and
the neighbor Node Bs receiving the neighbor cell channel updating information, and updating the information of the user terminal in the uplink multi-cell joint detection information.

3. The method according to claim 1, further comprising:
the radio network controller sending a neighbor cell channel deletion information to the neighbor Node Bs when the Node B application part protocol process happens at the Iub interface to delete the radio link of the user terminal; and
the neighbor Node Bs deleting the information of the user terminal in the uplink multi-cell joint detection information after receiving the neighbor cell channel deletion information.

4. The method according to claim 1, wherein the Node B application part protocol process to establish the radio link for the user terminal includes a radio link setup process or a radio link addition process.

5. The method according to claim 1, wherein the neighbor Node Bs of the cell where the user terminal is located are Node Bs where cells which are found from neighbor cells of the cell where the user terminal is located are located, the neighbor Node Bs including a cell which contains a frequency point at which the established radio link is present and is the cell where uplink joint detection is required to be performed for the user terminal.

6. The method according to claim 1, wherein the neighbor cell channel updating information includes a user terminal identifier as well as a carrier frequency on which the established radio link is present and a physical channel occupied by the established radio link.

7. The method according to claim 6, wherein the neighbor cell channel updating information further includes scrambling codes of the cell where the user terminal is located and a list of cells where uplink joint detection is required to be performed by the neighbor Node Bs.

8. The method according to claim 3, wherein the neighbor cell channel deletion information includes a user terminal identifier.

9. The method according to claim 2, further comprising:
the radio network controller sending a neighbor cell channel deletion information to the neighbor Node Bs when the Node B application part protocol process happens at the Iub interface to delete the radio link_of the user terminal; and
the neighbor Node Bs deleting the information of the user terminal in the uplink multi-cell joint detection information after receiving the neighbor cell channel deletion information.

10. The method according to claim 2, wherein the neighbor Node Bs of the cell where the user terminal is located are Node Bs where cells which are found from neighbor cells of the cell where the user terminal is located are located, the neighbor Node Bs including a cell which contains a frequency point at which the established radio link is present and is the cell where uplink joint detection is required to be performed for the user terminal.

11. The method according to claim 2, wherein the neighbor cell channel updating information includes a user terminal identifier as well as a carrier frequency on which the established radio link is present and a physical channel occupied by the established radio link.
